(19) United States
(12) Patent Application Publication
(10) Pub. No.: US 2025/0290637 A1
(43) Pub. Date: Sep. 18, 2025

(54) SYSTEMS AND METHODS FOR MANUFACTURING PRECAST OUTDOOR FIREPLACES

(71) Applicant: Ideal Concrete Block Co., Westford, MA (US)

(72) Inventor: Stephen BURGOYNE, Westford, MA (US)

(21) Appl. No.: 19/083,162

(22) Filed: Mar. 18, 2025

Related U.S. Application Data
(60) Provisional application No. 63/566,820, filed on Mar. 18, 2024.
(60) Provisional application No. 63/566,821, filed on Mar. 18, 2024.

(51) Int. Cl. F24B 1/195; B28B 1/14; E04F 17/02

(52) U.S. Cl. CPC F24B 1/195; B28B 1/14; E04F 17/023

(57) ABSTRACT

A method for creating and molding an outdoor fireplace assembly using a molding process. The molding process includes molding a firebox housing unit having an outer layer and an inner layer mounting a plurality of bricks, wherein the outer layer and the inner layer are molded at the same time, molding a separate smoke chamber unit, and molding a separate chimney extension unit.

### RELATED APPLICATIONS

The present invention claims priority to U.S. provisional patent application Ser. No. 63/566,821, filed on Mar. 18, 2024, and entitled System And Method For Manufacturing An Outdoor Fireplace, and claims priority to U.S. provisional patent application Ser. No. 63/566,820, filed on Mar. 18, 2024, and entitled System And Method For Manufacturing An Outdoor Fireplace, the contents of which are herein incorporated by reference.

### BACKGROUND OF THE INVENTION

Outdoor fireplaces have long been a favored addition to residential and commercial spaces, offering warmth, ambiance, and a focal point for gatherings. While outdoor fireplaces are a popular addition to residential and commercial spaces, constructing or building the fireplaces or assembling the fireplaces from kits is time consuming and expensive. Despite the appeal of design flexibility and customization, these traditional methods present significant drawbacks that outweigh their benefits. Building the outdoor fireplaces from raw material (e.g., from scratch) or from a kit requires considerable effort and extended construction time, typically multiple days just to achieve a veneer-ready structure. This prolonged timeline can disrupt outdoor spaces and increase labor costs. Further, conventional fireplaces are often not fully cured when exposed to heat for the first time, compromising the structural integrity of the fireplace. Premature exposure to heat can cause cracking, thus weakening the fireplace before the structure has an opportunity to stabilize.

Inconsistent firebox construction is another problem associated with conventional fireplaces, which can hinder proper drafting. Poor drafting in the conventional fireplaces can lead to smoke buildup, inefficient burning, and reduced heat output, making the fireplace less enjoyable and less effective. Additionally, materials used in constructing the traditional fireplaces may not optimize thermal performance, resulting in significant heat loss and uneven heat distribution. Further, outdoor fireplaces are exposed to constant weather fluctuations, which accelerates wear and deterioration. Issues such as cracking, spalling, and discoloration are common. Because fireboxes are often built independently from the outer structure, repairing localized damage can be particularly challenging and costly.

### SUMMARY OF THE INVENTION

In light of these shortcomings, there exists a need for an improved precast outdoor fireplace solution that addresses the limitations of conventional fireplace designs while offering enhanced versatility, functionality, and heat performance. The present invention aims to fulfill this need by introducing a modular outdoor fireplace system capable of overcoming the aforementioned drawbacks.

The present invention is directed to forming a fireplace assembly from a precast or molded firebox housing unit, smoke chamber unit, and chimney extension component. The firebox housing unit can have an outer layer and an inner layer of firebrick that are molded in place together, at the same time, during a molding process.

The present invention is directed to a system and associated method for creating and molding an outdoor fireplace assembly using a molding process. The method of the present invention, including for example molding process, can include molding a firebox housing unit having an outer layer and an inner layer mounting a plurality of bricks, wherein the outer layer and the inner layer are formed at the same time, molding a separate smoke chamber unit, and molding a separate chimney extension unit.

The step of molding the firebox housing unit with the molding process can include providing a firebox housing mold having a first mold component for forming the outer layer and a second mold component for forming the inner layer, and pouring concrete into the firebox housing mold so as to form, as a single unit, the inner layer and the outer layer of the firebox housing unit using the molding process to form a single cast molding process where the inner layer is attached to the outer layer during the single cast molding process. The first mold component can include a mold receptacle forming a central reservoir, and the second mold component can include a mold support element and a plurality of mold retaining elements. The mold support element can be coupled to the first mold component and seated within the receptacle and is configured to support the plurality of mold retaining elements. The plurality of mold retaining elements can be coupled to the mold support element. Each of the plurality of mold support elements can include one or more raised surface features forming a plurality of retaining chambers, where each of the plurality of retaining chambers are sized and configured for seating at least a portion of a brick. The brick can be firebrick.

Further, the method of the present invention can include the step of molding a separate smoke chamber unit using the molding process. The method can include providing a smoke chamber mold and pouring concrete into the smoke chamber mold to form the smoke chamber unit. Similarly, the step of molding a separate chimney extension unit using the molding process can include providing a chimney extension mold and pouring concrete into the chimney extension mold to form the chimney extension unit.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a perspective view of a precast modular fireplace assembly according to the teachings of the present invention.

FIG. 2 is a perspective view of a firebox housing unit forming part of the fireplace assembly of FIG. 1 according to the teachings of the present invention.

FIG. 3 is a perspective view of a smoke chamber unit forming part of the fireplace assembly of FIG. 1 according to the teachings of the present invention.

FIG. 4 is a perspective view of a chimney extension component forming part of the fireplace assembly of FIG. 1 according to the teachings of the present invention.

FIG. 5A is a flow chart diagram showing the steps of molding the firebox housing unit according to the teachings of the present invention.

FIG. 5B is a flow chart diagram showing the steps of molding the smoke chamber unit according to the teachings of the present invention.

FIG. 5C is a flow chart diagram showing the steps of molding the chimney extension component according to the teachings of the present invention.

FIG. 6A is a perspective view of a firebox housing mold suitable for forming the firebox housing unit of the fireplace assembly of FIG. 1 according to the teachings of the present invention.

FIG. 6B is a perspective view of a mold retaining component of the firebox housing mold of FIG. 6A suitable for mounting firebrick according to the teachings of the present invention.

### DETAILED DESCRIPTION OF THE INVENTION

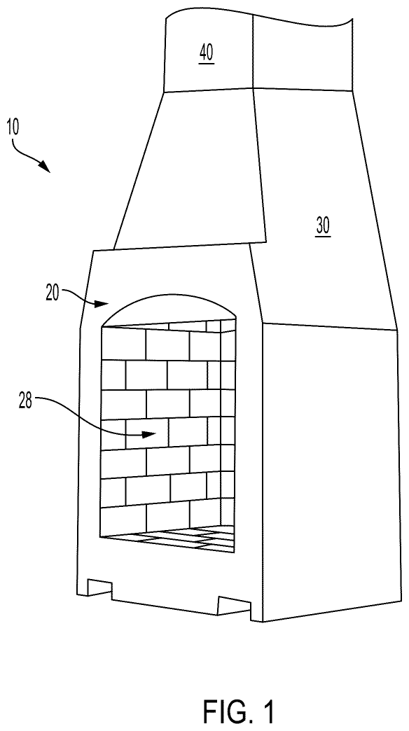

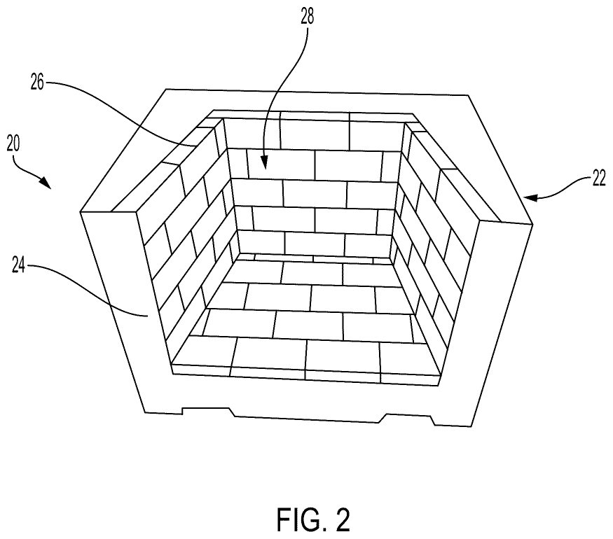

The present invention is directed to a precast modular outdoor fireplace assembly that includes a precast firebox housing unit, a precast smoke chamber unit, and a precast extension component. As shown for example in FIGS. 1-2, the illustrated firebox assembly 10 can be formed using a cast molding process to form each section or component of the precast fireplace assembly. The firebox assembly 10 can include a firebox housing unit 20 that has a main body 22 that can be formed from multiple different layers formed from multiple different types of material using a precast molding process that employs a firebox housing mold. As used herein, the term “mold” is intended to mean or refer to a form or cavity structure configured to receive a pourable or flowable material, such as concrete, so as to shape and define the structural features of a component of the fireplace assembly 10. The mold can include for example a negative cavity formation ensuring proper dimensional accuracy, alignment, and surface finish. The mold can be formed from any suitable type of material, such as fiberglass, steel, silicone, rubber, or reinforced plywood, and can be configured as a single-use or reusable mold with separable sections to facilitate demolding of the precast component after curing. The mold can also include any selected number of parts or components. The mold can be used as part of a molding process. As used herein, the term “molding process” is intended to mean or refer to a manufacturing technique or process for forming a selected component or section of the fireplace assembly 10 by introducing a refractory concrete or concrete mixture into a mold, allowing the material to conform to the shape of the mold cavity, and subjecting the material to a controlled curing process. The molding process can include pour casting, vibratory compaction, steam curing, and reinforcement embedding to enhance structural integrity and heat resistance. The molding process can further include demolding, surface finishing, and quality control procedures to ensure each molded component meets dimensional and performance specifications for integration into the fireplace assembly 10. As used herein, the term “concrete” is intended to mean or refer to a composite material formed by mixing selected components together. The components can include a binder, such as hydraulic cement, with aggregates and water, which undergoes a chemical hydration reaction to harden into a solid structure. The composition can include additional additives or admixtures to modify its physical and chemical properties of the resultant concrete. Example types of cement can include Portland cement (e.g., Portland cement, sand, gravel, and water), reinforced concrete, precast concrete, high-performance concrete, lightweight concrete (employs low-density aggregates), self-consolidating concrete, refractory concrete (employs refractory aggregates), composite concrete, and the like. Concrete is essentially a mixture because it consists of multiple components that do not chemically combine into a single homogeneous substance but rather maintain distinct roles within the hardened material.

The main body 22 of the cast firebox housing unit 20 can include an outer layer 24 composed of a first material 24, such as concrete, forming a housing and an inner layer 26 formed of a second material that is different than the first material. The inner layer 26 can be formed from any suitable heat resistant material, such as for example brick and specifically firebrick. The firebox housing unit 20 can have any selected shape, size and configuration, and can be customized for an end user. As used herein, the term “brick” is intended to mean or refer to a solid or perforated building unit composed of a ceramic, refractory, cementitious, or composite material, typically formed into a rectangular shape and used in construction for structural, thermal, or decorative purposes. Bricks can be manufactured through molding, extrusion, or pressing and subsequently hardened through suitable processes, such as firing, curing, or chemical bonding. A firebrick, also referred to as a refractory brick, is a type of ceramic brick specifically designed to withstand high temperatures, thermal shock, and chemical exposure without degrading. Firebricks are typically composed of refractory materials such as high-alumina, silica, or magnesia-based compounds and are manufactured through a high-temperature firing process to enhance their heat resistance. Firebricks are used for example in kilns, furnaces, fireplaces, industrial ovens, and other high-heat applications where conventional bricks may fail due to thermal stress.

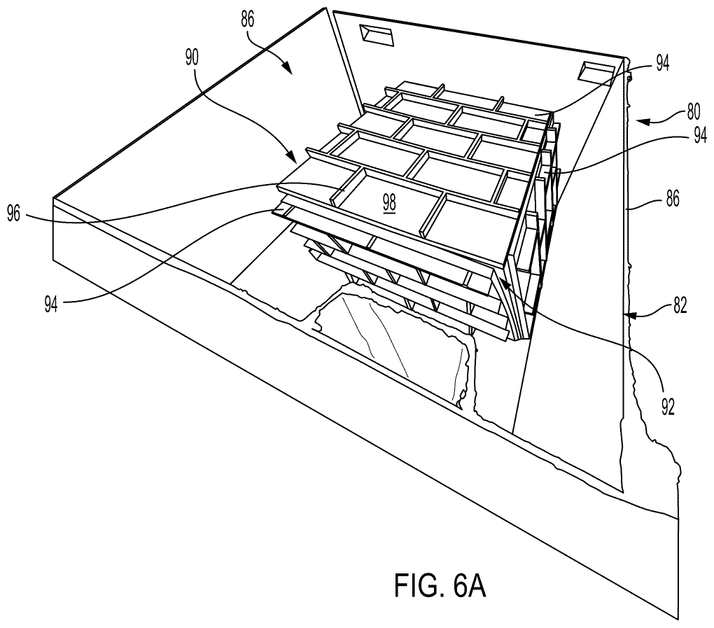

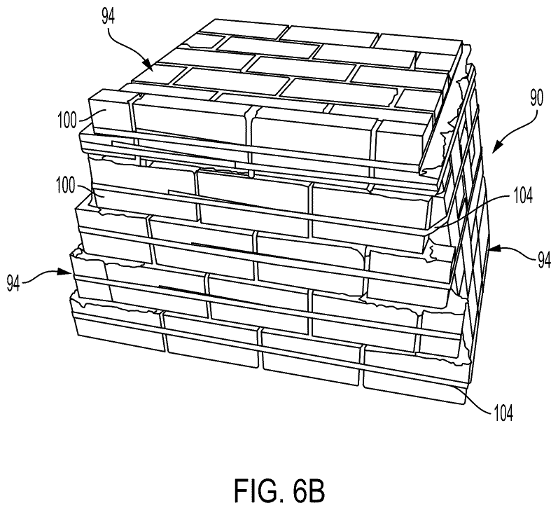

The molding process can include the formation and use of one or more firebox housing molds for allowing for the pouring and curing of concrete therein to form the outer layer 24 of the firebox housing unit 20 and for holding and applying the firebrick to the housing outer layer 24 to form the inner layer 26. According to one embodiment, the firebox housing mold can include two or more mold components that are coupled together or are used as part of the same molding process to form the firebox housing unit 20. According to one embodiment, as shown in FIGS. 6A and 6B, the firebox housing mold 80 can include a first mold component 82 and a second mold component 90. The first and second mold components can be secured or coupled together through known techniques, such as by bolting. The first mold component 82 can be in the form of a mold box that can include a series of sides 84 that form a reservoir 86 that is sized and shaped similar to the size and shape of the product to be cast or molded, such as the firebox housing unit 20. The first mold component 82 can be formed from metal, such as steel. The firebox housing mold 80 can also include a second mold component 90 that seats or is mounted within the reservoir 84 of the first mold component 82 and is coupled thereto. The second mold component 90 can be formed as a single mold component or can include multiple components. According to one embodiment, the second mold component 90 can include a mold support element 92 that is configured so as to support one or more mold retaining elements 94 (e.g., rubber molds). The mold retaining elements 94 can be configured to have one or more and preferably a series of raised surface features or protuberances 96 that are connected together to form a series of retaining chambers 98 that can be sized and configured to hold a brick, such as a firebrick 100. The retaining chambers 98 can hold or retain the firebrick in place during the molding process. The mold retaining elements 94 help form uniform joint lines for the firebrick and help align the brick in the mold during the casting process. The second mold component 90 can optionally employ one or more retention elements 104, such as bands or straps, that can be used to secure the mold retaining elements 94 together on the mold support element 92 once the firebrick has been mounted thereto. The retention elements can optionally remain on the mold retaining elements 94 during casting to help strengthen and support the firebox housing unit 20. The first mold component 82 can be configured for forming the outer layer 24 and for seating and accommodating the second mold component 90. An optional release agent, such as silicone or wax based compounds, can be applied to prevent the concrete from adhering to the first and second mold components. According to one embodiment, the combination of the first and second mold components 82, 90 can be employed to cast the outer layer 24 of the firebox housing unit 20 and the inner layer 26 (e.g., the firebrick lining) at the same time to form an integral firebox housing unit 20. Once the bricks are mounted within the retaining chambers 98 of the mold retaining element 94, and the second mold component 90 is seated within the first mold component 82, the concrete can be poured into the reservoir 86 so as to fill the reservoir and to cover the second mold component 90. The concrete is then allowed to set to form the firebox housing unit 20.

The outer layer 24 can then be cured for any selected period of time in a controlled environment and at a selected or suitable temperature (e.g., 50-75° F.). Once the outer layer 24 is cured or partially cured, the firebox housing mold can be removed. The firebox housing unit 20 and the firebrick forming the inner layer 26 can be attached or coupled together in a single cast or molding process where the firebrick is attached to the housing outer layer 24 during the initial pour of the firebox housing unit. The single cast or mold process reduces labor, cost and time, and enables the firebrick forming the inner layer 26 to be properly aligned and secured to the outer layer 24. Further, by casting the firebrick or inner layer 26 with the housing outer layer 24 at the same time, the firebrick adhesion can be as strong, if not stronger, than if applied to the firebox housing post casting. Further, the firebrick can be properly positioned, aligned, leveled, and adhered to the housing outer layer 24 (e.g., concrete) and the molding process helps address and overcome any surface imperfections in the firebrick. Consequently, the firebrick can be properly aligned to form the inner layer and the brick jointing (e.g., spaces between the bricks) can be controlled and relatively uniform. The inner layer 26 of the firebox housing unit 20 forms a firebox 28. The concrete forming the housing outer layer 24 can include, for example, multiple ones of high-temperature refractory cement (e.g., calcium aluminate-based), reinforced aggregates (e.g., silica sand, perlite, and vermiculite), fiberglass or reinforcement fibers for added strength, water, and plasticizers to improve flowability

The precast modular fireplace assembly 10 can include multiple additional precast and modular components and can be configured to allow for predictable expansion and contraction in each of the components (e.g., isolated areas). Each component of the precast modular outdoor fireplace assembly can be exposed to different temperatures throughout the heat cycle. Due to the temperature variations, the precast modular outdoor fireplace system enables the section to be exposed to different temperature profiles and thus isolated to specific or predictable temperature ranges. This helps mitigate the amount of expansion cracks or separation that occurs between each section of the system. By effectively mitigating the severity of cracking and expansion, the precast modular outdoor fireplace system has a longer life span.

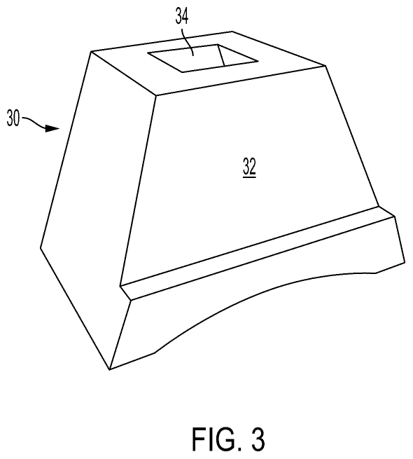

As shown in FIGS. 1 and 3, the illustrated fireplace assembly 10 can further include a smoke chamber unit 30 that can be coupled to the firebox housing unit 20. The smoke chamber unit 30 helps facilitate the transition of smoke, hot gases and heat from the firebox 28 of the firebox housing unit 20 to the remaining portions of the fireplace assembly 10. As shown in FIG. 3, the illustrated smoke chamber unit 30 has a main body 32 that can have any selected shape, such as for example a tapered shape or configuration, so as to channel or funnel the smoke, gases and heat into a central opening 34, which can function as part of a chimney flue. The tapered shape of the smoke chamber unit 30 helps reduce turbulence and helps create a draft effect, allowing the hot air and gases to rise efficiently and preventing backdrafts into the firebox 28. Similar to the firebox housing unit 20, the smoke chamber unit 30 can be cast using a smoke chamber mold assembly having a first or outer mold forming a chamber having a selected design or configuration that can be optionally formed from removable walls or supports. The smoke chamber mold can also include a mold core for seating or mounting within the outer mold for helping form the central opening 34. The concrete that is employed to form the smoke chamber unit 30 can then be poured into the smoke chamber mold. The smoke chamber unit 30 can thus be formed from materials similar to the materials forming the outer layer 24 of the firebox housing unit 20.

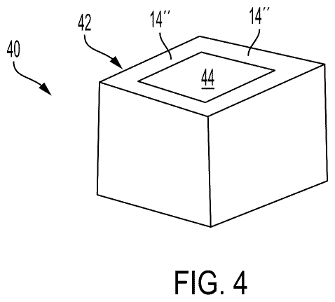

As shown in FIGS. 1 and 4, the illustrated fireplace assembly 10 can also include a chimney extension component 40 that is sized and configured for seating on the smoke chamber unit 30 when assembled therewith. The chimney extension component 40 provides height to the fireplace assembly 10 to enhance the draft effect and ensure proper ventilation of the firebox 28. The chimney extension component 40 also protects against downdrafts and improves the stability of smoke movement away from the firebox 28. The illustrated chimney extension component 40 has a main body 42 having a central opening 44 that also forms part of the chimney flue of the fireplace assembly 10. The central opening 44 can be aligned with and in fluid communication with the opening 34 to form the chimney flue when the chimney extension component 40 is coupled or mounted to the smoke chamber unit 30. The chimney extension component 40 can be formed from any suitable material, such as concrete. According to one embodiment, the outer layer 24 of the firebox housing unit 20, the smoke chamber unit 30, and the chimney extension component 40 can be formed from a similar material. The chimney extension component 40 can be formed by employing a chimney extension mold assembly. The chimney extension mold assembly can include a main outer mold component or box optionally formed from removable walls or supports and a chimney core mold element that can be disposed within the mold box to help form the central opening 44. The mold core can be seated within or mounted to the main mold box. The concrete mixture that is employed to form the chimney extension component 40 can then be poured into the chimney extension mold assembly.

The concrete that is poured into the various molds to form the various components of the fireplace assembly 10 can be allowed to set by remaining in the respective molds for a selected period of time, such as for example by allowing the concrete to set for a period of time between about 16 hours and about 18 hours, before the molds and any associated supports are removed.

The precast modular outdoor fireplace assembly 10 can be assembled using the precast and molded firebox housing unit 20, smoke chamber unit 30, and chimney extension component 40 and can be joined together by placing the smoke chamber unit 30 on the firebox housing unit 20 and securing the units together with a selected securing material, such as for example by using a heat resistant joint mortar and the like. A scratch coat of mortar can be applied to the assembled firebox housing unit 20 and smoke chamber unit 30 and to the separate chimney extension. The scratch coat can form a veneer ready surface. The mortar is allowed to set for a selected period of time, such as for example, 4 hours. The assembled units are then placed on a transportation pallet and the chimney extension component 40 can be temporarily placed in the firebox 28 of the assembled unit during transportation. The chimney extension component 40 can subsequently be mounted to seated on the smoke chamber unit 30.

Still further, the molds employed for each component or section of the precast modular outdoor fireplace assembly 10 have a selected design or configuration that allows the assembly to be demolded in two selected steps postproduction. Utilizing this technology speeds up the manufacturing process and yields a cleaner finished product, all while significantly reducing labor costs.

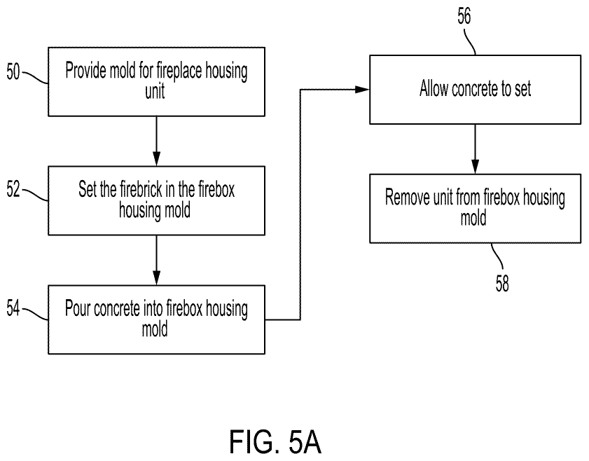

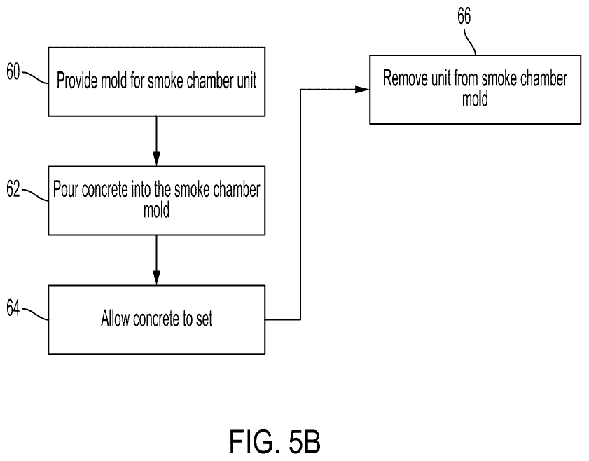

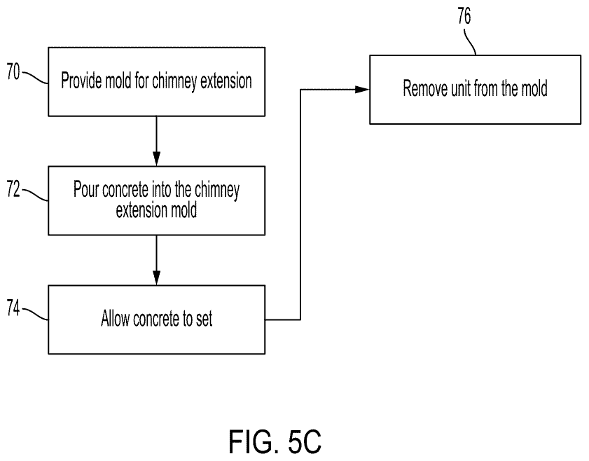

The method for casting or molding the firebox housing unit 20 is shown for example in FIG. 5A. The method for molding the firebox housing unit 20 includes providing a firebox housing mold, step 50. The firebox housing mold can include a first mold component and a second mold component for holding or retaining the firebrick during the molding process, step 52. The concrete suitable for forming the outer layer 24 of the firebox housing unit 20 can then be poured into the firebox housing mold, step 54, and specifically into the mold component that forms the housing or outer layer 24 of the firebox housing unit 20. The inner layer 26 formed of the firebrick is then cast or molded directly with the outer layer 24, at the same time, to form a single cast molding process. The concrete is then allowed to set within the firebox housing mold. The cast or molded firebox housing unit 20 can then be removed from the firebox housing mold, step 58. The firebox housing unit 20 can then be cured.

The method for casting or molding the smoke chamber unit 30 is shown in FIG. 5B. The method for molding the smoke chamber unit 30 includes providing a smoke chamber mold, step 60. The smoke chamber mold can optionally include a mold core that seats within an outer mold component for forming the central opening 34, which forms part of the chimney flue. The concrete suitable for forming the smoke chamber unit 30 is then poured into the smoke chamber mold, step 62. The concrete mixture is then allowed to set within the smoke chamber mold, step 64. The cast or molded smoke chamber unit 30 can then be removed from the smoke chamber mold, step 66. The smoke chamber unit 30 can then be cured.

The method for casting or molding the chimney extension component 40 is shown in FIG. 5C. The method for molding the chimney extension component 40 includes providing a chimney extension mold, step 70. The chimney extension mold can optionally include a mold component or mold core that seats within or is mounted to an outer mold element for forming the central opening 44, which also forms part of the chimney flue. The concrete suitable for forming the chimney extension component 40 is then poured into the chimney extension mold, step 72. The concrete is then allowed to set within the chimney extension mold, step 74. The cast or molded chimney extension component 40 can then be removed from the chimney extension mold, step 76. The chimney extension component 40 can then be cured.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

I claim:

1. A method for molding an outdoor fireplace assembly using a molding process, comprising
molding a firebox housing unit having an outer layer and an inner layer mounting a plurality of bricks, wherein the outer layer and the inner layer are formed at the same time,
molding a separate smoke chamber unit, and
molding a separate chimney extension unit.

2. The method of claim 1, wherein the step of molding the firebox housing unit with the molding process comprises
providing a firebox housing mold having a first mold component for forming the outer layer and a second mold component for forming the inner layer, and
pouring concrete into the firebox housing mold so as to form, as a single unit, the inner layer and the outer layer of the firebox housing unit using the molding process to form a single cast molding process where the inner layer is attached to the outer layer during the single cast molding process.

3. The method of claim 2, wherein the first mold component includes a mold receptacle forming a central reservoir, and the second mold component includes a mold support element and a plurality of mold retaining elements, wherein the mold support element is coupled to the first mold component and seated within the receptacle and is configured to support the plurality of mold retaining elements, wherein the plurality of mold retaining elements are coupled to the mold support element.

4. The method of claim 3, wherein each of the plurality of mold support elements has one or more raised surface features forming a plurality of retaining chambers, wherein each of the plurality of retaining chambers are sized and configured for seating at least a portion of a brick.

5. The method of claim 4, wherein the brick is firebrick.

6. The method of claim 5, wherein the step of molding a separate smoke chamber unit using the molding process comprises
providing a smoke chamber mold, and
pouring concrete into the smoke chamber mold to form the smoke chamber unit.

7. The method of claim 6, wherein the step of molding a separate chimney extension unit using the molding process, comprises
providing a chimney extension mold, and
pouring concrete into the chimney extension mold to form the chimney extension unit.
